(19) United States
(12) Patent Application Publication
(10) Pub. No.: US 2004/0010522 A1
(43) Pub. Date: Jan. 15, 2004

(54) Method and system for detecting significant changes in dynamic datasets

(76) Inventor: Thomas Aaron Shulok, San Diego, CA (US)

Correspondence Address: THOMAS A. SHULOK, 7056 PARK MESA WAY, #40, SAN DIEGO, CA, 92111-5648, US

(21) Appl. No.: 10/155,927

(22) Filed: May 24, 2002

(51) Int. Cl. G06F 15/173

(52) U.S. Cl. 707/201; 709/223

(57) ABSTRACT

An improved change-detection method and system that periodically evaluates differences between samples of a dataset in the context of the dataset's derived historic variability to notify a client of significant changes in the dataset. By parsing the dataset samples and comparing corresponding sections of the samples, the system identifies changed sections of the dataset. The changed sections are evaluated against the dataset's historic section variability, which is derived from an analysis of prior samples of the dataset. If the variability analysis indicates that a changed section is not historically prone to change, the system generates a change notification to a client. If the variability analysis indicates the section is prone to change, no notification is generated. Thus, the client does not receive notification of changes to sections of the dataset that are inherently prone to change. The system substantially reduces the frequency of unnecessary change notifications and thereby improves the quality of change notification without requiring excessive configuration by the client.

### FEDERALLY SPONSORED RESEARCH

Not applicable.

### SEQUENCE LISTING OR PROGRAM

Not applicable.

### CROSS-REFERENCE TO RELATED APPLICATIONS

Not applicable.

### BACKGROUND OF THE INVENTION

This invention relates to the analysis of variable datasets, specifically using a computer to analyze and monitor datasets to detect desired forms of data variability.

Description of Prior Art

Change detection systems arose from a client's need to be aware of altered data. The most basic incarnation of a change detection system is one that performs a complete comparison of all the elements of two distinct dataset samples and signals a change based on one or more differences between corresponding elements of the samples. More efficient systems including U.S. Pat. No. 5,388,255 to Pytlik et al. were developed that rely on timestamps. Whenever the contents of the dataset are changed, a timestamp reflecting the date and time of modification is associated with the dataset. By comparing the timestamp of an old sample with the timestamp of a new sample, a change is signaled if the timestamps differ. While this approach was a substantial improvement in efficiency, it introduced an external element, the timestamp, which was extrinsic to the dataset. This external element adds considerable overhead in maintaining these systems since an extrinsic element must be accommodated both by a producer of the dataset as well as a consumer of the dataset. Moreover, any change to the representation of the timestamp by the producer requires a coordinated change to the consumer's processing of the timestamp.

Subsequently, checksums including U.S. Pat. No. 6,219,818 to Freivald et al. and U.S. Pat. No. 5,978,842 to Noble et al. were employed to not only maintain a similar level of efficiency, but also to remove the requirement of an extrinsic element. A checksum is a numerical quantity derived from the dataset itself, and is calculated by treating the dataset's constituent items as numeric values. A checksum is typically the sum-value of all the bytes of data in the dataset, modulo the maximum integer supported by the system generating the checksum. Since the checksum is derived from the dataset itself, no additional extrinsic data element is required. A checksum, however, is not infallible. A dataset could conceivably vary in a way that some bytes were removed and others added to the dataset to produce the same checksum value. In such cases, a change would go undetected since the two checksums are identical. To remedy this deficiency, cyclic redundancy checks (CRCs) were then employed including U.S. Pat. No. 5,898,836 to Freivald et al. to improve the quality of checksum-based change detection. A CRC performs a specific mathematical calculation on a block of data and returns a number that represents the content and organization of that data. In essence, a CRC treats the entire dataset as one large binary number. This large binary number is divided by a carefully selected divisor, known as a polynomial, and the remainder from that division is regarded as a number that uniquely identifies the dataset sample. By comparing the remainders from CRCs performed on two dataset samples, one can infer differences in the underlying datasets if their remainders are not the same. This number, though often referred to as a checksum, is more resistant to the situation described above that causes conventional checksums to fail when changes in the two datasets cancel each other out and produce the same checksum. Although the CRC is more reliable than an ordinary checksum, the CRC can still fail to detect changes in the underlying dataset, especially if the polynomial is poorly chosen.

Checksums and cyclic redundancy checks were originally created to perform error detection in data transmission systems. As such, they are designed to detect any and all changes to a given dataset, usually in the context of what was sent versus what was received. Consequently, the key problem with both approaches is that they do not properly account for datasets that are intrinsically variable. As a simple example, web pages from the World Wide Web often have an element that contains the current date and time. A conventional system monitoring such a web page would signal a change as soon as the time advanced to the next minute and the time element of the web page changed. The change to the web page's time element would quite correctly signal a change to systems employing a timestamp, a checksum, or a CRC. Signaling such a change is useless, however, since a change will be signaled every minute. Timestamps, checksums, and CRCs are ill suited for monitoring datasets like web pages that often exhibit natural variability.

Up to this point, any and all changes to the dataset were deemed significant to the client and thus signaled. The notion of a material, or significant, change is construed as a change to a dataset that has meaning or significance to the client. One attempt at addressing the concept of a material change, in U.S. Pat. No. 5,898,836 to Freivald et al., and U.S. Pat. No. 5,983,268 to Freivald, et al., requires the user to explicitly choose particular subsections of the dataset to monitor and then applies a CRC to those subsections. The hope being, the subsection chosen by the user will only exhibit desired variability. By choosing a particular section of a web document, for example, the user explicitly designates that a change in that section represents a material change to the entire web document. This time-consuming approach requires the user to explicitly specify individual subsections for every dataset of interest. Moreover, the user does not necessarily have a priori knowledge of a dataset's intrinsic variability, so may erroneously over-specify the section of interest and hence receive undesired change notifications. Worse, by the converse reasoning, the user may under-specify the section of interest and not be notified of an important change. Additionally, this system does not incorporate any additional feedback once the monitoring has begun. If the user has erroneously under-specified or over-specified a subsection, the error cannot be remedied without restarting the entire monitoring process. Further, the system described by Freivald works only with web pages, which is a significant limitation given the profusion of data available in digital formats including databases, local and network file systems, and data that can be received through the variety of ports on a typical computer including serial, parallel, and network ports. Finally, the system as described works only in a server configuration where the user interacts via a browser with a remote server that performs all the processing. Such a configuration limits the applicability and availability of the detection capability to web pages existing outside a firewall and available directly over the Internet. Moreover, the browser-based interface does not afford the user a high degree of customization over aspects of the detection process, relying instead on user or system-wide defaults.

Another attempt to address the problem of dataset variability is found in U.S. Pat. No. 6,012,087 to Freivald et al. In this patent a history of checksums from individual pages is maintained, and if a checksum recurs, a change is not reported. While this approach will reduce the overall number of redundant notifications, it does nothing to directly address the inherent dataset variability problem. Returning to the earlier example of a web page with an embedded element that contains the current time, a new and unique checksum, and hence an unnecessary notification, will be generated each time the page is sampled after the embedded time element advances. Moreover, this approach doesn't address the variability that can occur when web pages are vended by multiple machines in a server farm. A server farm is a group of machines dedicated to serving the web page requests of a particular web site. Any individual client request can go to any machine in the server farm. An individual machine in a server farm may not have an identical configuration to the other machines, so a request that is served by that machine can actually differ in content from an identical request vended at the same time by another machine in the server farm. The two identical requests will have different checksums, so a change will be unnecessarily signaled whenever a page is sampled from a machine that does not share the dominant server farm configuration. Such transient checksums will generate false notifications, and the differences in machine configurations will continue to generate false notifications whenever a portion of the monitored web site is changed.

Checksums and CRCs were originally employed to detect errors in data transmission. As such, they are a static, highly compressed representation of a single collection of data. Checksums and CRCs were designed to detect any and all data transmission errors, or differences between what was sent and what was received. While they are well suited to transmission error detection, checksums and CRCs are incapable of encoding any additional context about the collection of data they represent which makes them ill-suited for performing intelligent change detection. Much of the discussed prior art is devoted to extending the ill-suited application of checksums and CRCs, but suffers from important and common deficiencies:

(a) None of the foregoing mechanisms, timestamps, checksums, cyclic redundancy checks, or specific user direction in conjunction with CRCs, can adequately address the detection of material changes in datasets that can potentially exhibit both material and immaterial changes.

Requiring additional user interaction to ameliorate the deficiencies of the underlying mechanism introduces additional problems:

(b) The user must specify any and all subsections of interest before monitoring can begin. Given a large number of complex datasets, this can be a laborious and error-prone process.

(c) To prevent false notifications, the user must have in depth knowledge of what segments in each dataset are not prone to immaterial change.

(d) To prevent unreported changes, the user must have in depth knowledge of what segments in each dataset are prone to immaterial change.

(e) Once monitoring has begun, the user cannot fine-tune the detection process by providing additional feedback. The user must restart the entire process to incorporate the new feedback.

(f) In U.S. Pat. No. 5,898,836 to Freivald et al., the system is limited to performing change detection on HTML documents residing on the Internet. This is a serious limitation considering the proliferation of documents on local file systems, network file systems, intranets, and extranets.

(g) In U.S. Pat. No. 5,898,836 to Freivald et al., the system as claimed works only in a web server configuration with clients accessing it through a web browser. A web browser substantially limits the richness of user interaction, and as such limits the amount of configuration and customization available to the user, relying instead on predetermined defaults. Moreover, the system operating as a web server on the Internet requires the user to have an active connection to the Internet to use it, and can only be used to monitor web pages freely available over the Internet. Local or intranet pages are typically protected by a firewall, and cannot be monitored by an external system.

(h) Maintaining a history of notification-generating checksums for a given web page only eliminates redundant notifications. It does nothing to address a web page's intrinsic variability since the CRC is constructed from a single page and has no capability to measure page variability. The client still receives unnecessary notifications and is vulnerable to changes in irrelevant content.

(i) Systems that employ checksums and CRCs are vulnerable to inconsistent server farm configurations. Web pages vended from certain machines in a server farm that do not share the prevailing software configuration of other machines in the server farm can vary from those web pages served by the other machines, thus causing checksum and CRC-based systems to unnecessarily signal a change to the user.

### OBJECTS AND ADVANTAGES

Accordingly, several objects and advantages of the present invention are:

(a) To provide a method and a system to facilitate the detection of material changes in datasets that potentially exhibit both material and immaterial changes.

(b) To free the user from explicitly specifying particular subsections of a dataset to monitor before monitoring can begin.

(c) To reduce false change notifications by not requiring the user know what parts of the document are prone to change.

(d) To eliminate unreported changes by not requiring the user to know what parts of the document are not prone to change.

(e) To perform change detection on a wide variety of datasets, including but not limited to, web pages, local file systems, network file systems, databases and database result sets and any data that can be received and processed by a computer.

(f) To provide a flexible mode of operation whereby the system can operate on a client computer, on a server, or in a peer-to-peer mode.

(g) To provide a high degree of user-control in specifying the scope and duration of the variability analysis to accommodate a wide range of potential dataset variability.

(h) To provide a mechanism that maintains a variability analysis of prior samples and optionally applies them to a candidate sample to see if the candidate sample's variability is distinct from prior forms of observed variability.

(i) To further reduce false notifications by ignoring certain samples that demonstrate unusual and transient variability. Such samples are often vended from specific machines in a server farm that do not share the prevailing software configuration of other machines in the server farm. Such samples can also be the result of temporary communication problems with the data source.

(j) To give the user greater flexibility in specifying the monitoring frequency of a dataset, effectively ranging from microseconds to days.

Further objects and advantages of my invention will become apparent from a consideration of the drawings and ensuing description.

### SUMMARY

In accordance with the present invention, a method and a system for detecting significant changes in dynamic datasets comprises a variability analysis of elements of the dataset coupled with change-detection predicated on the results of the variability analysis. Initially, a client submits a dataset for change-detection by registering a dataset descriptor with the system. Using the dataset descriptor, the system retrieves a reference sample of the dataset from a data source. The reference sample is divided into sections using a predetermined section delimiter and the sections are stored. After a predefined time interval, the system retrieves a profiling sample of the dataset. The profiling sample is divided into sections using the section delimiter. The profiling sample is archived. The process of acquiring, parsing, and archiving a profiling sample is periodically repeated until a predetermined number of profiling samples is obtained. After the profiling samples are obtained, the system periodically retrieves a candidate sample of the dataset. The candidate sample is divided into sections using the section delimiter. The system compares the sections of the candidate sample to corresponding sections of the archived reference sample. If a section of the candidate sample is not equivalent to a corresponding section of the reference sample, the system consults the dataset's historic variability by evaluating the profiling samples. The system retrieves the archived profiling samples of the dataset. If the corresponding section in the profiling samples is substantially equivalent to the section from the reference sample, the section of the dataset is determined to be invariant. Since the candidate sample differs from the reference sample in an invariant section, the system generates a change notification. If the corresponding section of at least one profiling sample differs from the reference sample, the section is determined to be a variant section. The system does not generate a change notification for a variant section and continues comparing the remaining corresponding sections of the candidate sample and the reference sample to find any material changes. By analyzing samples of a dataset for inherent variability, the system ignores changes to sections of the dataset that have historically demonstrated variability, notifying the client only when a change occurs in a section of the dataset that has not shown historic variability.

### DRAWINGS

Drawing Figures

FIG. 1A shows an overview of a preferred embodiment with relationships between the major components.

FIG. 1B shows an alternative embodiment whereby a client is connected to the requester, parser, and inspector to provide the client greater control over the detection tool.

FIG. 2 shows the acquisition, parsing, and archival of a reference sample from a data source.

FIG. 3 shows the acquisition, parsing, and archival of a profiling sample from a data source.

FIG. 4 shows the acquisition, parsing, and inspection of a candidate sample without a material change.

FIG. 5 shows the acquisition, parsing, and inspection of a candidate sample with a material change.

FIG. 6 shows an overview of the change detection process.

FIG. 7 shows the processing of a reference sample.

FIG. 8 shows the processing of profiling samples.

FIG. 9 shows the initial processing of a candidate sample.

FIG. 10 shows an overview of the inspection of a candidate sample.

FIG. 11 shows the determination of variance for a dataset section.

FIG. 12A shows the generation of a variability profile for a profiling sample.

FIG. 12B shows the refinement of a variability profile using subsequent profiling samples.

FIG. 13 shows the determination of variance for a dataset section using a variability profile.

Reference Numerals in Drawings

| | |
|---|---|
| 30 | client |
| 32 | requestor |
| 34 | data source |
| 36 | storage |
| 38 | parser |
| 40 | inspector |
| 42 | change detection tool |

### DETAILED DESCRIPTION

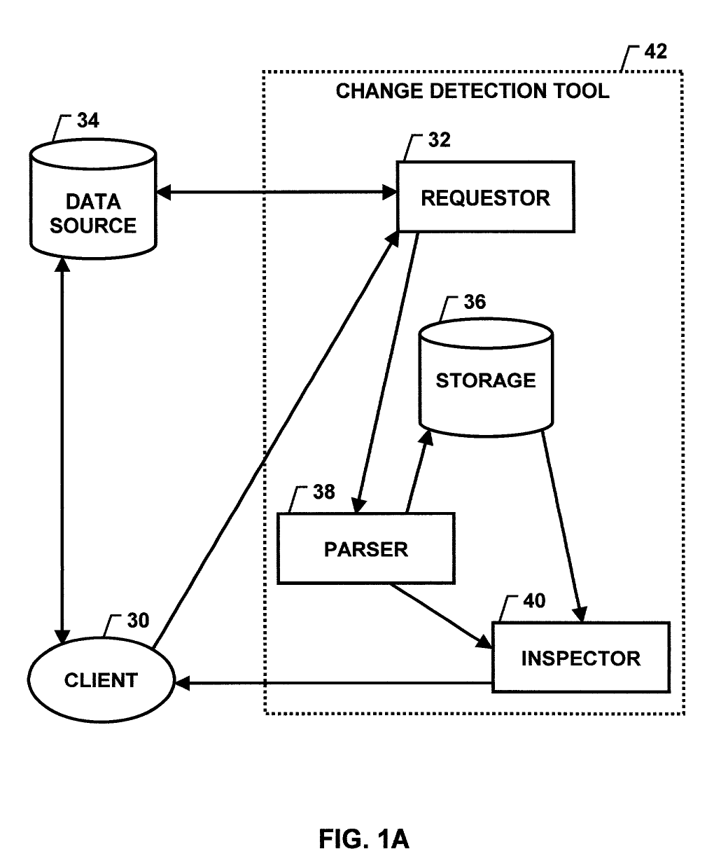

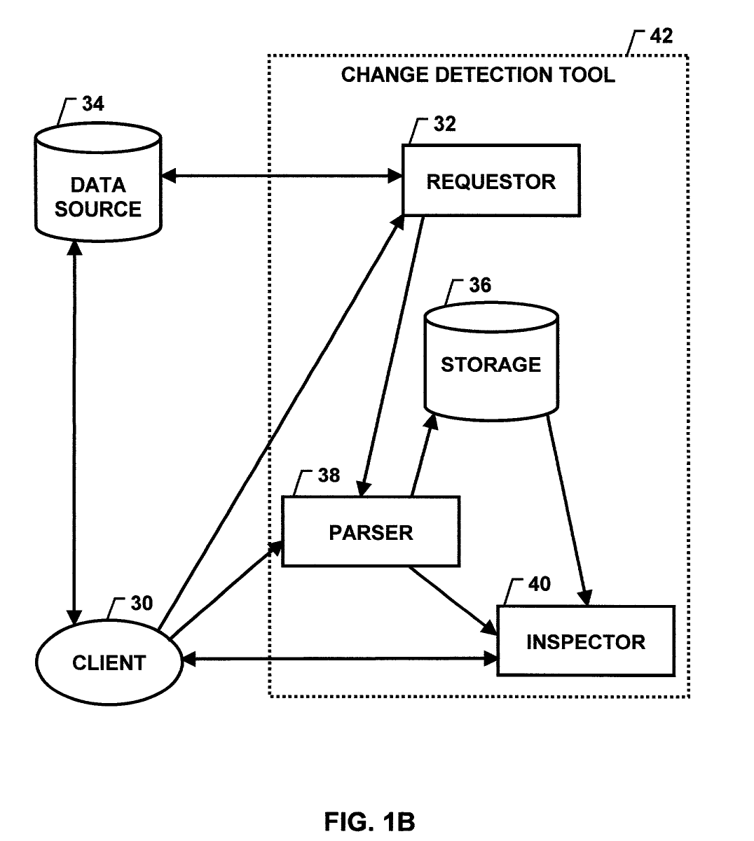

Description FIG. 1A—Preferred Embodiment

An overview of a preferred embodiment is illustrated in FIG. 1A. If client 30 is manually monitoring a dataset of data source 34, the client can retrieve an initial sample of the dataset, then periodically retrieve a new sample of the dataset from the data source. Usually, the new sample is identical to the initial sample. However, the client is only interested if the dataset has changed from the original sample, and more importantly, if the dataset has changed in a significant way. For example, documents on the World Wide Web often have embedded timestamps that change every minute. Such a change is of no interest to the client. Web pages often have built-in advertisements that also change frequently. Again, the client is only interested if something significant, or material, has changed on the web page. The client is not interested if merely an advertising banner on the page has changed. Moreover, any particular web page will vary in a manner distinct from any other web page. A web page's variability is dependent on the individual elements that comprise the page. A web page is an obvious example of a dynamic dataset, and the inherent variability of a particular web page makes the process of automated change detection difficult. A typical automated change detection tool will signal a change when any of the described irrelevant changes are found. To solve this problem, the inventor has developed a software change detection system that first analyzes a dataset for variability and then uses the analysis to determine when a significant change has occurred in the dataset.

Rather than assume that all changes in the dataset are meaningful, the change detection tool analyzes the dataset for intrinsic variability before monitoring it for changes. The client 30, which may be a person or another software program, interacts with change detection tool 42 by sending bytes of data that represent a descriptor that uniquely describes a data source and a dataset. The change detection tool uses the descriptor to retrieve a sample of the dataset from the specified data source. Periodically, the change detection tool acquires additional samples of the dataset and uses those samples to perform a variability analysis on the dataset. Once the analysis is complete, the change detection tool begins monitoring the data set for meaningful changes by periodically retrieving a new sample of the dataset. By using the dataset's derived variability analysis, the system inspects the new sample for changes to areas of the document that have not historically changed. If a change is detected in one of these areas, the change detection tool signals the change to the client.

Change detection tool 42 performs five basic functions:

1. Register a dataset for change detection.

2. Acquire, parse into sections, and archive a reference sample and at least one profiling sample of the dataset.

3. Periodically acquire and parse into sections a candidate sample of the dataset.

4. Compare the sections of the candidate sample to the corresponding sections of the archived reference sample using the archived profiling samples to assess the significance of any differences.

5. Provide an indication to the client if a significant difference is detected between the samples.

Change detection tool 42 contains four basic components. Requestor 32 communicates with the client to register datasets for change detection using dataset descriptors provided by the client. The format of the descriptor conforms to a well-known uniform resource locator (URL) specification that describes both a source of data, usually by a domain name or Internet protocol (IP) address, as well as a specific dataset from within the data source. A URL can represent World Wide Web pages, computer files and directories, database result sets, or any dataset whose location can be precisely described by the URL. Using standard URL domain name resolution techniques, requester 32 uses the descriptor to locate data source 34 that contains the described dataset. Depending on the location of the dataset described by the descriptor, the requestor can use a network connection to communicate with a remote data source or can retrieve the dataset directly from a local data source. The requestor periodically retrieves dataset samples from data source 34 using the dataset descriptor to identify the registered dataset.

Parser 38 receives dataset samples from the requestor. The parser first receives a reference sample, followed by a predetermined number of profiling samples, and then periodically receives candidate samples. In a typical implementation, the period between candidate samples is one minute, but can effectively range between one microsecond to several days depending on the ability to access and process a sample and the client's desire for timely change notification. If more than one profiling sample is desired, the profiling samples are acquired periodically. The period between profiling samples is one minute, but can effectively range between one microsecond to several days depending on the ability to access and process a sample. The number and periodicity of the profiling samples influences the quality of the analysis. An analysis derived from a significant number of frequent samples typically provides a more accurate representation of a dataset's variability, and hence improves the quality of change notification for the dataset.

The parser separates dataset samples into sections using the bytes representing a carriage return as a section delimiter. Each section contains at most one delimiter. If the last section of the sample does not have a carriage return at the end, one is assumed. The parser archives the reference sample sections and profiling sample sections in storage 36. Inspector 40 compares corresponding sections of dataset samples. The inspector receives candidate samples from the parser and retrieves the archived reference sample and the archived profiling samples from the storage. The inspector compares a reference sample and a candidate sample of the dataset by examining the corresponding sections of each sample for significant differences. Two sections are corresponding sections if they have the same ordinal position, also known as ordinality, within their respective samples. In other words, the first section in the reference sample corresponds to the first section of the candidate sample. When a difference is found between the two corresponding sections, the inspector retrieves the archived profiling samples for the dataset. If the corresponding section in the profiling samples is equivalent to the section from the reference sample, the inspector signals a change notification to client 30.

Description FIG. 1B—Alternative Embodiments

By increasing the richness of the client's connection to the change detection tool as shown in FIG. 1B, the tool can be enhanced by giving the client greater control over the detection process. By connecting the client to the requester, the client can control the frequency and number of profiling samples. The client can also control the frequency of candidate samples. With this capability, the client can tailor the analysis and detection to the characteristics of a particular dataset. By connecting the client to the parser, the parser can be enhanced to use at least one client-defined section delimiter in place of the carriage return. If the client specifies multiple delimiters, a section of a sample will contain at most one delimiter. Since the delimiter governs the granularity of the dataset analysis, this capability affords the client more precise control over the analysis and change-detection of a particular dataset. The client can be connected to the inspector to control the notification process. For example, the inspector can be enhanced to ignore a client-defined number of samples exhibiting significant changes. By adding this capability, the tool is less susceptible to signaling changes for spurious dataset samples. A spurious sample can be created when the connection between the requester and the data source fails or when the data source itself is temporarily unable to provide a dataset sample.

By connecting the client to the inspector, the client can also fine-tune the detection process by providing feedback during the detection process without being required to restart the detection process. When the inspector sends a change notification to the client, the client can respond by vetoing the notification. The inspector will use the client's input to designate the section responsible for the change as variant and resume the monitoring process. Since the section is now designated as variant, it will not generate future notifications. Since the analysis is not restarted, the existing variability analysis is preserved.

The inspector can also be enhanced to accept the designation of specific words and phrases from the client. From the client's perspective, a change may be considered material only if the designated words are present in a materially changed section. When the inspector detects a material change in a sample, the absence of a particular character, word, or phrase in the materially changed section can prevent the notification from being sent to the client. For example, a litigator may monitor a corporate web site, but only be interested if the site changes materially and the designated term, ‘asbestos,’ appears in the materially changed section. This capability provides highly targeted change detection to the client. The client is notified of a change only when the change is determined to be in a material section of the dataset and the change contains client-specified content.

In a similar manner, a change can be considered material only if designated words are absent from a materially changed section. The inspector can be enhanced to prevent notification if a designated character, word, or phrase is found in a materially changed section. For example, a client monitoring a site can prevent unnecessary notifications by requiring the absence of the phrase, ‘site unavailable,’ when a material change is detected. Given such a designation, the inspector will not signal a change when a web site is not available to properly service the request. These content-specific capabilities give the client more precise control over the monitoring of a dataset and improve the precision and quality of change detection.

Instead of storing all the bytes of all the sections of all the profiling samples, the parser can create a variability profile to efficiently represent the variability of a dataset. The variability profile contains a variability indicator for each section in the dataset, and the ordinality of the indicator in the variability profile corresponds to the ordinality of a section in the dataset. To create the profile, the archived reference sample's sections are compared to corresponding sections of a profiling sample received from the requester. The parser compares the bytes of the two corresponding sections for equality. If a section of the profiling sample is not equal to the corresponding section of the reference sample, the section is designated as variant section. A profiling section that is equivalent to its corresponding reference section is designated as an invariant section. Collectively, the variability designations of the sections of the dataset comprise a variability profile for the dataset. The variability profile can be refined by comparing additional profiling samples to the reference sample. The corresponding section indicator in the profile is set to variant when a difference is detected between the reference sample section and a corresponding profiling sample section. After the analysis is complete, the variability profile is archived in storage 36. As described before, the inspector then compares a candidate sample's sections against the corresponding archived sections of the reference sample for inequality. If corresponding sections of the samples are not equal, however, the inspector retrieves the dataset's archived variability profile from storage. If the variability profile indicates that the section is an invariant section, the inspector signals the change notification to client 30. By storing a variability profile instead of the profiling samples, the system requires less archival space, and performs change detection more efficiently by performing a single comparison to determine section variability when examining a suspect candidate sample section.

A variety of dynamic and static data compression mechanisms including Lempel-Ziv compression, checksums, and cyclic redundancy checks are well known to those with skill in the art. Any of these or similar methods can be applied singularly or in combination to reduce the storage requirements of the samples and improve the efficiency of change detection.

The tool can be enhanced to concurrently monitor multiple datasets. The requester can send the parser the associated dataset descriptor with a sample, and the parser can archive the sample with its descriptor. The parser can also pass the descriptor with a candidate sample to the inspector. The inspector can use the descriptor to identify the samples in the storage that belong to a particular dataset and retrieve the appropriate samples. The inspector can include the descriptor in a change notification to the client so the client will know which dataset has changed.

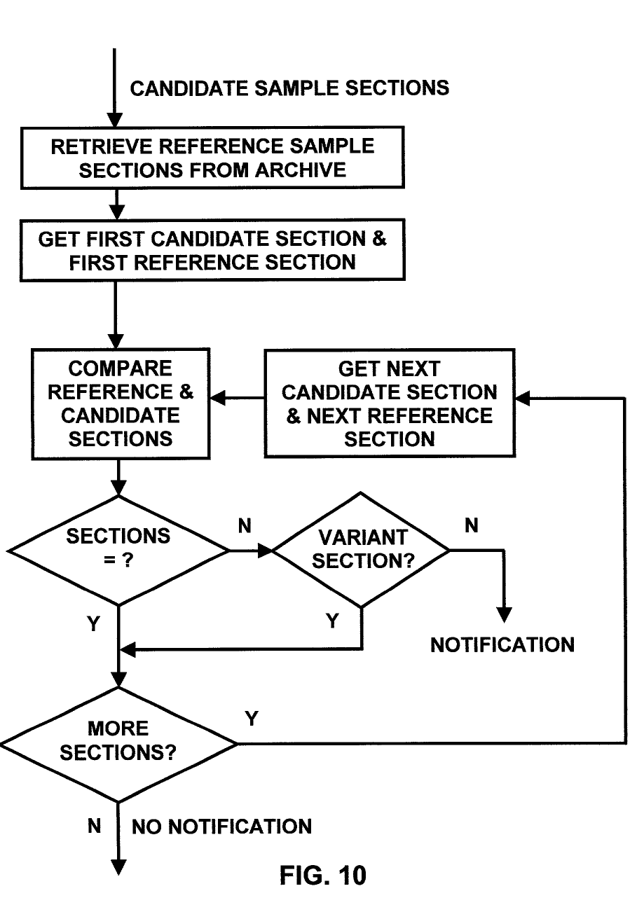

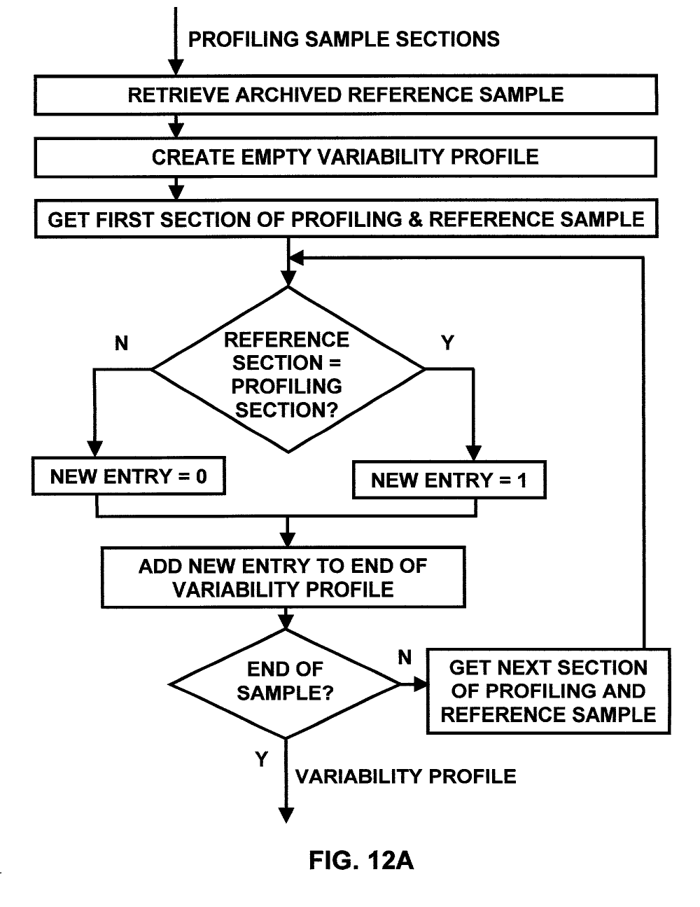

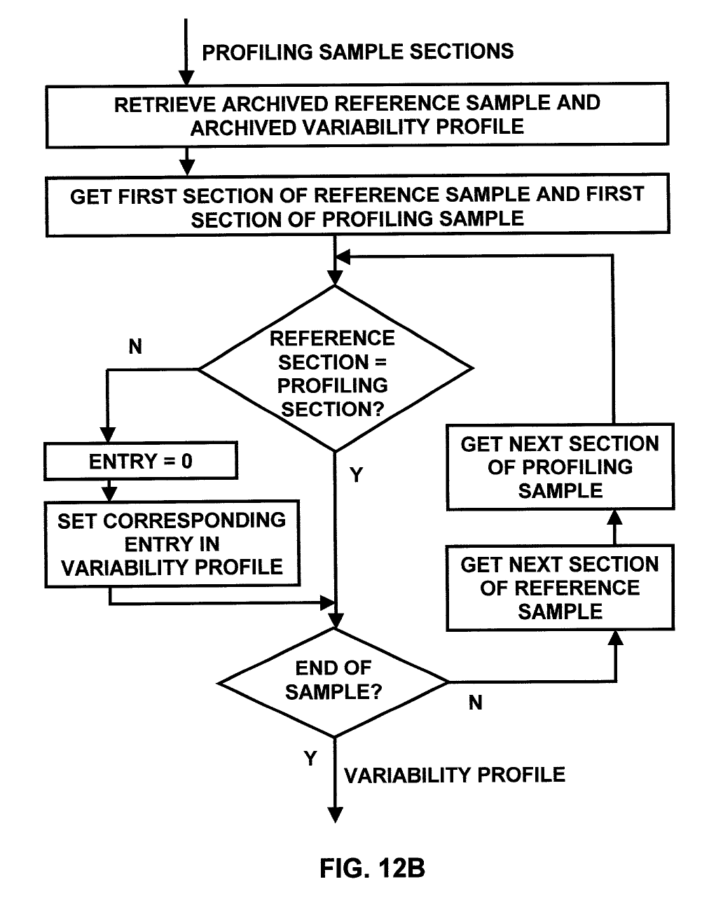

The fundamental detection algorithm can be expressed in a variety of ways. For example, the algorithm depicted in FIG. 10 can be modified to first determine if a section of a sample is variant. If a section is variant there is no need to compare the corresponding reference and candidate sections. Even if the corresponding section of the reference and candidate samples is different, no change will be signaled for a variant section, so no comparison is necessary. Reference and candidate sections are compared only when they are determined to be in an invariant section. The performance improvement is significant when coupled with the variability profile created in FIGS. 12A and 12B. Such optimizations of the basic algorithm will be apparent to one with skill in the art.

Advantages

From the description above, a number of advantages of the invention become evident:

(a) Foremost, the described system frees the client from repeatedly checking dynamic data sources for material changes. This benefit not only can be seen by using the system in conjunction with data sources on the World Wide Web, where it relieves the client from unnecessarily using the Reload or Refresh buttons on a web browser, but also extends to any realm where information changes over time. The system can be employed to monitor files on a corporate network to notify collaborators when a someone has made a change to a common document, or monitor an individual's own local data storage to notify the client that files have been added to a particular directory as frequently happens in peer-to-peer computing.

(b) By first analyzing the dataset for variability, the system can save the client substantial time by automatically eliminating most irrelevant change notifications.

(c) By automatically determining what elements are not of interest to the client, the system relieves the client of the time-consuming and error-prone task of manually enumerating and specifying elements of interest.

(d) By allowing the client to specify section delimiters for a dataset, the system supports an arbitrary granularity of detection ranging from entire documents residing in a directory to a highly granular sub-element of an individual document.

(e) The system automatically tailors a variability profile to a particular information source with minimal client interaction.

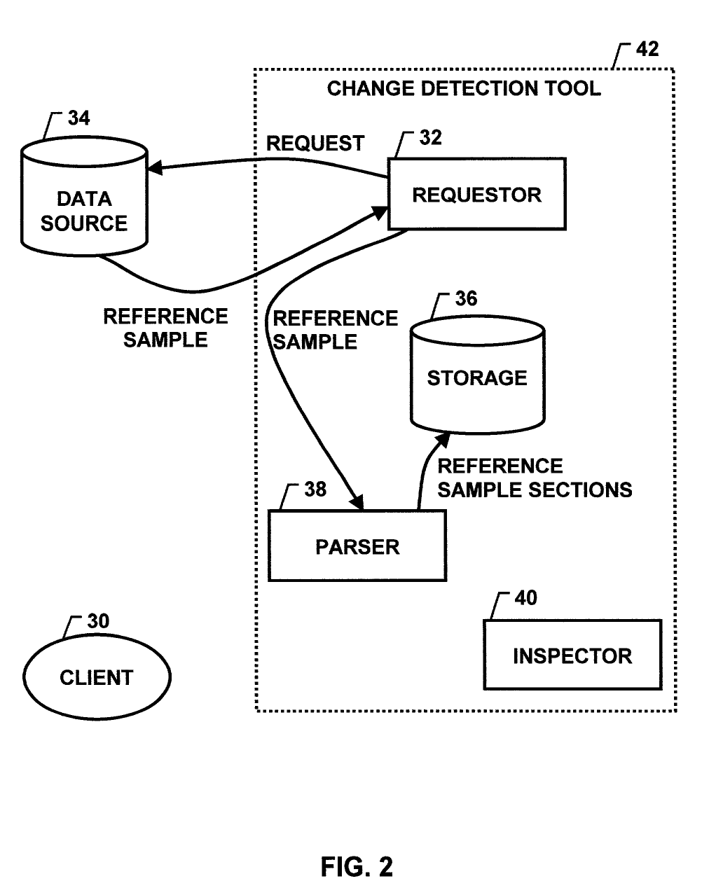

Operation—FIGS. 2, 3, 4, 5, 6, 7, 8, 9, 10, 11, 12A, 12B, 13

FIG. 2 illustrates the beginning of the change detection process. Client 30, which can be a person or a computer program, initiates the change detection process by providing a dataset descriptor to requestor 32. The descriptor is in the format of a uniform resource locator (URL), which describes both the source of data as well as a specific dataset within that source. The requester uses the descriptor to locate data source 34 using well-known techniques to convert a portion of the URL into a unique Internet protocol (IP) address that identifies the location of the data source. The location of the data source can be local or remote. If the URL indicates a remote data source, the requestor must be connected to the remote source via a network. The requestor sends the descriptor to the data source to obtain a reference sample of the dataset. Data source 34 uses the descriptor to retrieve the dataset and returns the reference sample to requestor 32. The requestor sends the reference sample to parser 38. The parser separates the reference sample into sections using at least one predetermined section delimiter. The delimiter indicates the end of a section of the sample. If there is no delimiter at the end of the sample, one is assumed. Once the parser has separated the sample into sections, it archives the sections in storage 36.

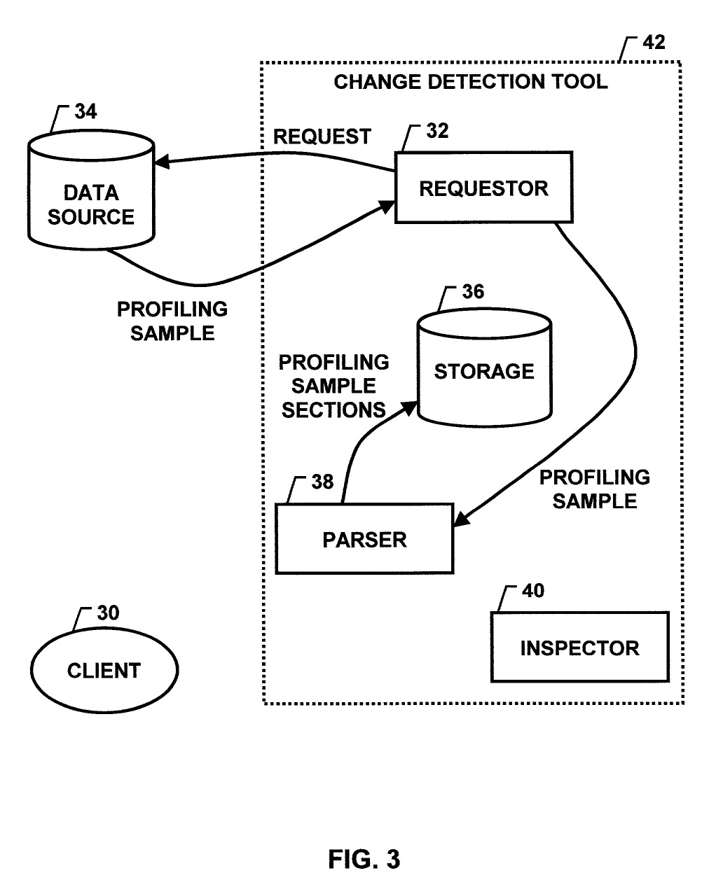

FIG. 3 shows the acquisition of a profiling sample. After a predetermined time interval, the requestor requests a profiling sample of the dataset from the data source by sending the descriptor to the data source. The data source uses the descriptor to retrieve the contents of dataset and returns it to the requestor. The requestor passes the profiling sample of the dataset to the parser. The parser separates the profiling sample into sections using the same delimiters that were used to parse the reference sample. The sections of the profiling sample are archived in the storage. Additional profiling samples are acquired periodically until a predetermined number of samples have been acquired, parsed, and archived.

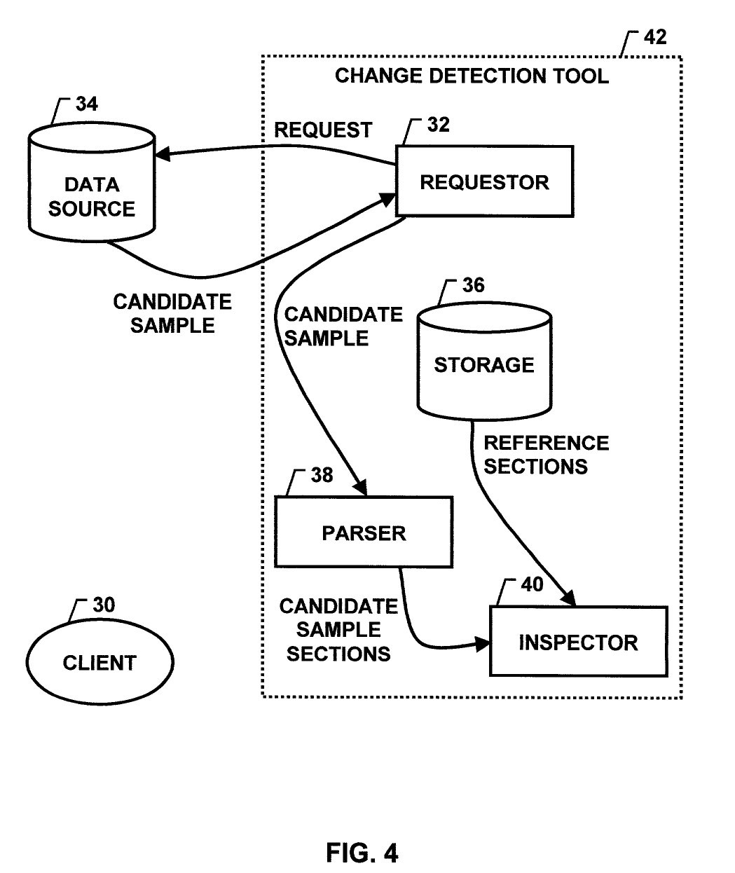

FIG. 4 shows the acquisition and processing of a candidate sample. After the profiling samples have been archived, and a predetermined time interval has elapsed, the requestor requests a candidate sample from the data source by sending the descriptor to the data source. The data source uses the descriptor to retrieve the contents of dataset and returns it to the requestor. The requestor passes the candidate sample of the dataset to the parser. The parser separates the candidate sample into sections using the same delimiters that were used to parse the reference and profiling samples. The sections of the profiling sample are sent to inspector 40. The inspector retrieves the archived reference sample sections from the storage. The inspector examines corresponding sections of the reference and candidate samples for equality. Two sections are corresponding sections if they have the same ordinality within their respective samples. In other words, the first section in the reference sample corresponds to the first section of the candidate sample. If all the corresponding sections are equivalent, no change is detected between the reference and candidate samples. The process shown in FIG. 4 is repeated periodically until a change is detected.

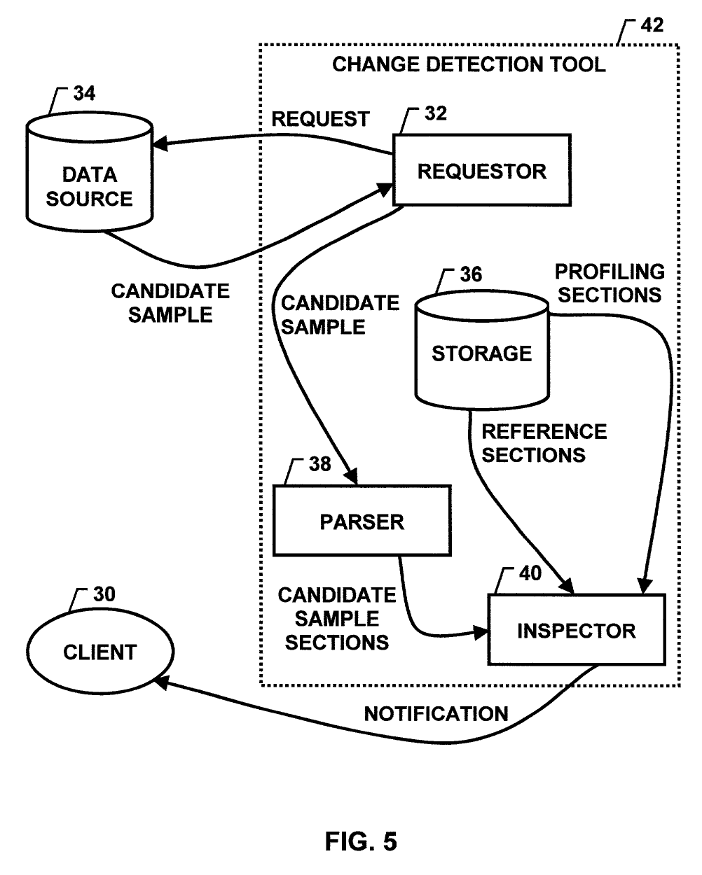

FIG. 5 shows the processing of a candidate sample with at least one detected material difference. The processing is similar to FIG. 4, except the inspector detects a difference between corresponding sections of the candidate sample and the reference sample. Since the samples differ, the inspector then retrieves the archived profiling samples for the dataset from the storage and compares the section in the reference sample to the corresponding sections of the profiling samples. No differences are detected between the reference section and the corresponding profiling sections, indicating the section is invariant. Since the candidate sample section is different from the corresponding reference section, and the section is determined to be invariant, a material change is detected. The inspector generates a change notification, and the change notification is sent to client 30. If at least one of the corresponding profiling sections is not equal to the reference section, the section is considered variant, and no material change is detected. If no material change is detected, the process shown in FIG. 4 is repeated periodically until a change is detected.

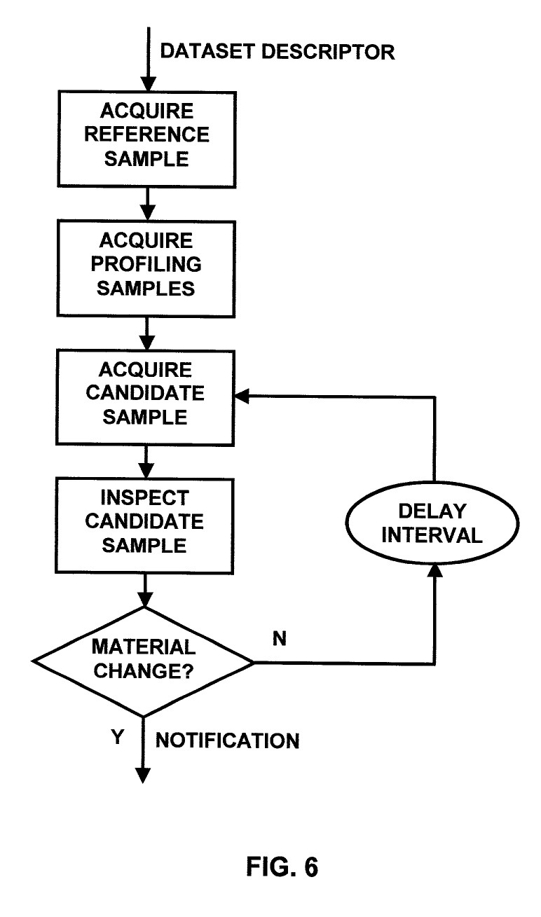

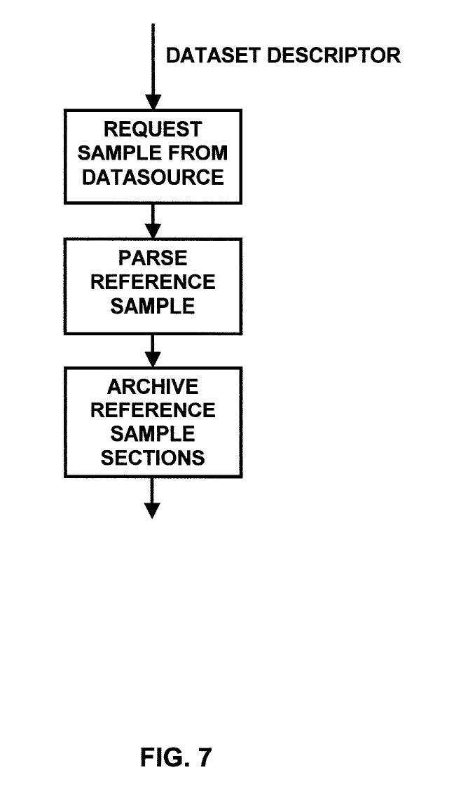

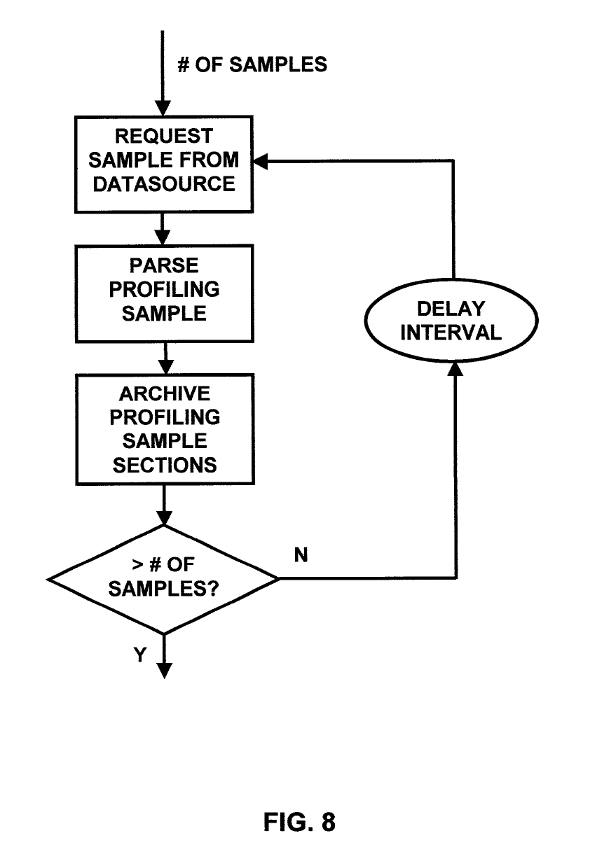

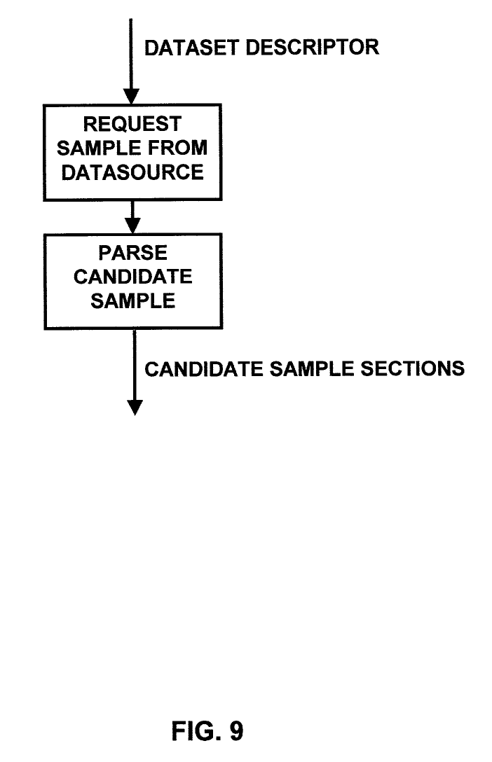

FIG. 6 shows an overview of the change-detection process. A reference sample is retrieved from a data source, parsed, and archived. After a predetermined time interval, a profiling sample is retrieved from the data source, parsed, and archived. This process is repeated until a predetermined number of profiling samples have been acquired. After a predetermined time interval, a candidate sample is retrieved from the data source and parsed into sections. The sections of the candidate sample are then compared to the corresponding sections of the reference and profiling samples to determine if a material change has occurred. If a material change is detected, a change notification is sent. If no material change has occurred, the system will periodically acquire and analyze a new candidate sample until a material change is detected or until the client terminates the process. FIG. 7, FIG. 8, and FIG. 9 show aspects of this process in greater detail. FIG. 7 shows the reference sample acquisition in detail. FIG. 8 shows the acquisition of profiling samples in detail. FIG. 9 shows the acquisition and parsing of a candidate sample in detail.

FIG. 10 shows the how the system uses the reference and profiling samples to determine a material change in the candidate sample. The archived reference sample sections are retrieved from storage. The corresponding sections of the reference sample and the candidate sample are compared for equality by examining the bytes that represent each section. If the sections are equal, the next set of corresponding sections is compared. This process repeats until all sections of the candidate sample are compared. If corresponding sections of the reference and candidate sample are not equal, the section is analyzed for variability. If the section is determined to be historically variable, no material change is detected for that section of the candidate sample, and the comparison proceeds to the next set of corresponding reference and candidate sections. If the section is determined to be historically invariant, a material change is detected and signaled.

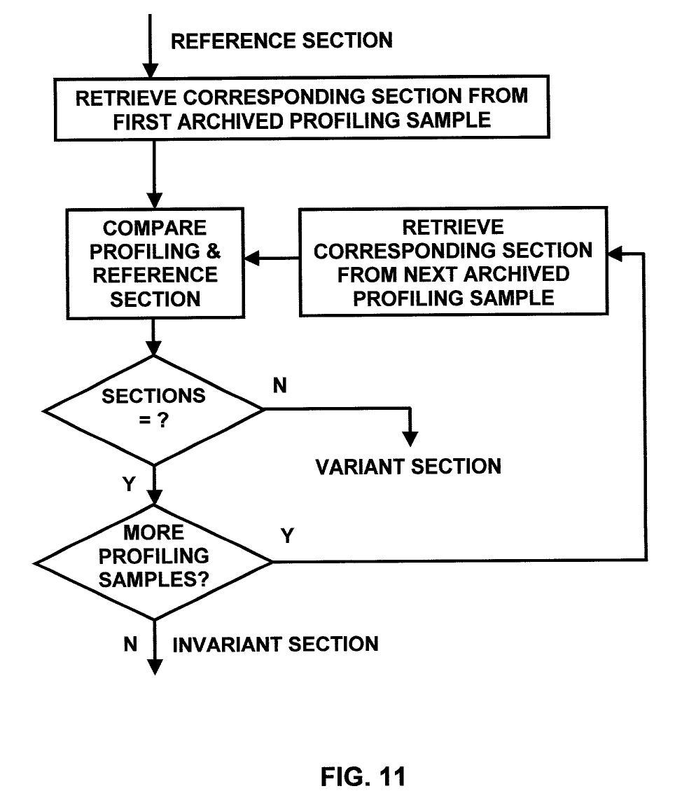

FIG. 11 shows the determination of variance for a dataset section. To determine the historical variability of a particular section of a dataset, the system compares the section from the reference sample to its corresponding sections from the profiling samples. If the section in the reference sample is equivalent to the section from the first archived profiling sample, the section from the reference sample is compared to the corresponding section from the next archived profiling sample. This process is repeated until all corresponding sections of the profiling samples have been compared to the section from the reference sample or until a difference is found. If any profiling section is not equivalent to the section from the reference sample, the section is determined to be variant. If all corresponding profiling sections are equivalent to the reference sample section, the section is determined to be invariant.

FIGS. 12A and 12B show the generation of an alternative representation for the profiling samples. Instead of archiving all the sections of all the profiling samples, the parser creates and stores only a variability profile, which is derived from the profiling samples. The variability profile is created when the first profiling sample is acquired and parsed. An entry in the profile corresponds to a section in the dataset. The corresponding entry in the variability profile is defined as an entry with the same ordinality as the section in its respective sample. In other words, the first entry in the variability profile corresponds to the first section of the profiling sample. FIG. 12A shows the creation of the variability profile. Each corresponding section of the reference sample and profiling sample are compared for equality. If the sections are equal, an entry is made in a corresponding position of the variability profile. In the figure, the numeric values zero and one are used to represent section variability and section invariability respectively. This process is repeated until all the sections of the profiling sample are compared to a corresponding section of the reference sample. The completed variability profile will have one element for each section of the profiling sample. The variability profile is archived in the storage. The sections of the profiling sample are not retained. The variability profile is subsequently refined with each additional profiling sample. FIG. 12B shows the refining of the variability profile. The comparison process is similar to FIG. 12A, except the variability profile is already created and thus retrieved from storage. A corresponding element of the variability profile is only changed to a variant indicator if a section of the profiling sample does not match the corresponding section of the reference sample. After the profiling sample has been processed, the variability profile is archived. This process shown in FIG. 12B is repeated for each additional profiling sample. When the creation of the variability profile is complete, an element with a numeric value of one indicates an invariant section of the dataset. An element with a numeric value of zero indicates a variant section of the dataset.

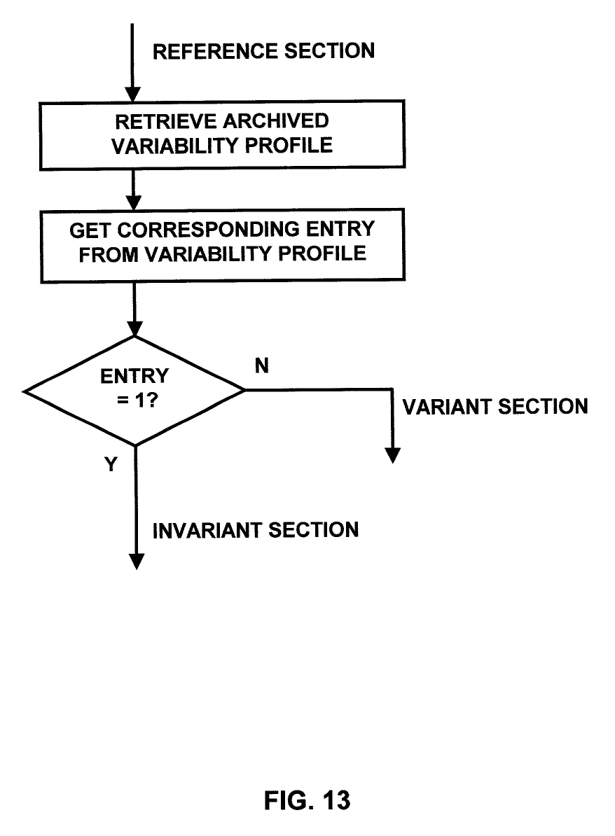

FIG. 13 shows the determination of a section's historic variability using a variability profile. The archived variability profile is retrieved. The element of the variability profile that corresponds to the reference section being analyzed is examined. If the value of the element indicates variability, the section is determined to be variant. If the value does not indicate section variability, the section is determined to be invariant.

### CONCLUSIONS, RAMIFICATIONS, AND SCOPE

Accordingly, the reader will see that the method and system described can provide substantial benefit in managing a large variety of dynamic datasets including web pages on intranets, extranets, and on the Internet as well as any other dynamic data source accessible by the system. By automatically analyzing a dataset to determine its natural variability, the invention obviates the need for time-intensive and error-prone user-involvement in the initial detection-configuration phases. The described method and system performs more reliable change detection by eliminating missed notifications and preventing false notifications by evaluating a change in the dataset against the context of the dataset's historic variability. The invention achieves this objective while requiring substantially less client direction than other detection methods. The described system works easily and effectively with a wide variety of dynamic datasets since it tailors a variability analysis to the particular dataset being monitored. As a result, the system does not require the client to have foreknowledge of a particular dataset's variability characteristics to effectively monitor the dataset for material or significant changes. The invention frees the client from manually checking and assessing changes in datasets of interest, dramatically simplifies the automation of the change detection process, and substantially improves the quality of change detection.

Although the foregoing description contains much specificity, it should not be construed as limiting the scope of the invention, but merely as providing illustrations of some of the presently preferred embodiments of this invention. Many variations of those embodiments are possible and evident to one with skill in the art. For example, the described system can form a part of a larger system with no direct client interaction or could be employed to sample arbitrary datasets using a frequency profile derived from an independent but related dataset.

Thus the scope of the invention should be determined by the appended claims and their legal equivalents, rather than by the examples given.

I claim:

1. A computer-implemented method for detecting significant changes in a dataset, comprising:
(a) registering a dataset for detection by receiving a dataset descriptor from a client,
(b) fetching a reference sample of said dataset from a data source by sending said dataset descriptor to said data source,
(c) dividing said reference sample into a plurality of sections using at least one predetermined section delimiter, a section defined as containing at most one section delimiter,
(d) storing a representation of said sections of said reference sample in a storage,
(e) after a period of time, fetching at least one profiling sample of said dataset from said data source by sending said dataset descriptor to said data source,
(f) dividing said profiling samples into a plurality of sections using said section delimiters, a section defined as containing at most one section delimiter,
(g) storing a representation of said sections of said profiling samples in said storage,
(h) after a period of time, fetching a candidate sample of said dataset from said data source by sending said dataset descriptor to said data source,
(i) dividing said candidate sample into a plurality of sections using said section delimiters, a section defined as containing at most one section delimiter,
(j) reading said reference sample and said profiling samples from said storage,
(k) comparing sections of said reference sample to corresponding sections of said candidate sample for substantial equality,
(l) signaling a significant change in said dataset to said client if a section of said reference sample is not substantially equivalent to said corresponding section of said candidate sample and said section of said reference sample is substantially equivalent to a corresponding section of said profiling samples,
(m) whereby a change is signaled to the client only for sections of the dataset that do not exhibit historic variability as evidenced by said profiling samples.

2. The method of claim 1 wherein said data descriptor of step (a) is a uniform resource locator, also known as a URL, wherein said URL identifies said dataset accessible by a location and a protocol contained within said URL, whereby a dataset that can be identified by said URL can be monitored for significant changes.

3. The method of claim 2 wherein said data source from step (b) is a web site server on the World Wide Web providing a web page in response to said data descriptor describing said web page, whereby said web page of said web site is monitored for significant changes.

4. The method of claim 2 wherein said data source from step (b) is a file system providing a listing of files and file modifications times of a file directory in response to said data descriptor describing said file directory, whereby said file directory is monitored for the modification of files that are not historically prone to modification.

5. The method of claim 1 wherein at least one said delimiter of step (c) is a sequence of bytes representing a carriage return, whereby said sample is divided into said sections according to the number of lines in said sample.

6. The method of claim 1 wherein at least one said delimiter of step (c) is specified by said client, whereby said client more precisely controls the analysis and detection of said dataset.

7. The method of claim 1 wherein said archived representation of said profiling samples comprises a sequence of identifiers wherein
(a) an identifier in said sequence represents a section of said profiling samples,
(b) the ordinality of said identifier in said sequence corresponds to the ordinality of said represented section,
(c) said identifier is a distinct value indicating said represented section's equivalence to a corresponding section in said reference sample only if said represented section is substantially equivalent to said corresponding section in said reference sample,
(d) the change detection of step (l) is refined to examine a corresponding entry of said sequence, when said corresponding sections of said candidate sample and said reference sample are not substantially equivalent, to determine the substantial equivalence of said corresponding section of said profiling samples to said corresponding section of said reference sample,
(e) whereby detection efficiency is improved by examining said identifiers of said sequence for section variability instead of comparing potentially long byte sequences of each corresponding section of said profiling samples, and storage efficiency is improved by storing said sequence of identifiers instead of said byte sequences.

8. The method of claim 1 wherein said signaling of step (l) is deferred until said significant change is detected in a predetermined number of candidate samples whereby transient sample anomalies and communication failures do not signal a material change to said client.

9. The method of claim 1 wherein said significantly changed section of said candidate sample of step (l) is further examined for the absence of a predetermined sequence of bytes wherein the absence of said sequence of bytes prevents said signaling of step (l), whereby change detection is refined to signal said significant change to said client only when said sequence of bytes, of particular interest to said client, appears in said significantly changed section of said candidate sample.

10. The method of claim 1 wherein said corresponding section of said candidate sample of step (k) is defined as a section preceded by the same number of delimiters as a section of said reference sample.

11. A system for detecting significant changes between a plurality of dataset samples, comprising:
(a) a computer processor means for processing data
(b) a storage means for storing data in a storage medium,
(c) a requestor means, coupled to a client, a data source, and a parser means, for obtaining a dataset descriptor from said client and using said descriptor to acquire a plurality of samples of a dataset from a data source, said samples comprising a reference sample, at least one profiling sample, and at least one candidate sample, said samples acquired periodically,
(d) said parser means, coupled to said requestor means, said storage means, and an inspector means, the parser means dividing said samples periodically acquired by said requester means into a plurality of sections using at least one predetermined section delimiter, storing a representation of sections of said reference sample and a representation of sections of said profiling samples in said storage means, sending sections of said candidate sample to said inspector means,
(e) said inspector means, coupled to said parser means, said storage means, and said client, for periodically inspecting sections of said candidate sample parsed by the parser means, retrieving said representation of said reference sample sections and said representation of said profiling sample sections from said storage means, said inspector means comparing for substantial inequality the sections of said candidate sample to corresponding sections of said reference sample, signaling a significant change to said client when both a section of said candidate sample is not substantially equivalent to the corresponding section of said reference sample and said section of said reference sample is substantially equivalent to the corresponding section of said profiling samples,
(f) whereby a change is detected by comparing corresponding sections of the dataset samples in the context of the section's historic variability as demonstrated by said profiling samples, wherein only a change in a section that does not exhibit historic variability is considered material, or significant, and signaled to said client.

12. The system of claim 11 wherein said requestor means is configured to use a uniform resource locator, also known as a URL, as said data descriptor wherein said URL identifies said dataset accessible by a location and a protocol contained within said URL, whereby a dataset that can be identified by said URL can be monitored for significant changes.

13. The system of claim 12 wherein said requester means is configured to access said data source as a web site server on the World Wide Web that provides a web page in response to said URL describing said web page, whereby said web page of said web site is monitored for significant changes.

14. The system of claim 12 wherein said requestor means is configured to access said data source as a file system providing a listing of files and file modification times of a file directory in response to said URL describing said file directory, whereby said file directory is monitored for the modification of files that are not historically prone to modification.

15. The system of claim 11 wherein said parser means is configured to use one delimiter which is a sequence of bytes representing a carriage return, whereby said dataset sample is divided into said sections according to the number of lines in said dataset sample.

16. The system of claim 11 wherein said parser means is configured to use at least one delimiter specified by said client, whereby said client more precisely controls the analysis and detection of said dataset.

17. The system of claim 11 wherein said parser means is configured to archive a representation of said profiling samples comprising a sequence of identifiers wherein
(a) an identifier in said sequence represents a section of said profiling samples,
(b) the ordinality of said identifier in said sequence corresponds to the ordinality of said represented section,
(c) said identifier is a distinct value indicating said represented section's equivalence to a corresponding section in said reference sample only if said represented section is substantially equivalent to said corresponding section in said reference sample,
(d) said inspector means is refined to examine said sequence when corresponding sections of said candidate sample and said reference sample are not substantially equivalent, using a corresponding entry of said sequence to determine the substantial equivalence of said corresponding section of said profiling samples to said section of said reference sample,
(e) whereby detection efficiency is improved by examining said identifiers of said sequence for section variability instead of comparing potentially long byte sequences of each corresponding section of said profiling samples, and storage efficiency is improved by storing said sequence of identifiers instead of said byte sequences.

18. The system of claim 11 wherein said inspector means is configured to defer the notification of said significant change until said significant change is detected in a predetermined number of successive candidate samples whereby transient sample anomalies and communication failures do not signal said significant change to said client.

19. The system of claim 11 wherein said inspector means is configured to further examine said significantly changed section of said candidate sample for the absence of a predetermined sequence of bytes specified by said client wherein the absence of said predetermined sequence of bytes prevents said notification, whereby change detection is refined to signal said significant change only when said predetermined sequence of bytes, of particular interest to said client, appears in said significantly changed section of said candidate sample.

20. The system of claim 11 wherein said inspector means is configured to determine said corresponding section of said reference sample as a section preceded by the same number of delimiters as a section of said candidate sample.
